(19) United States
(12) Patent Application Publication
(10) Pub. No.: US 2024/0278501 A1
(43) Pub. Date: Aug. 22, 2024

(54) LOCAL AEROSOL EVACUATION SYSTEMS FOR ADDITIVE MANUFACTURING SYSTEMS

(71) Applicant: Applied Research in Acoustics LLC, Madison, VA (US)

(72) Inventor: Jonathan Wesley Christian, Madison, VA (US)

(21) Appl. No.: 18/392,781

(22) Filed: Dec. 21, 2023

Related U.S. Application Data
(60) Provisional application No. 63/486,061, filed on Feb. 21, 2023.

(51) Int. Cl. B29C 64/364; B29C 64/118; B29C 64/209; B29C 64/245; B29C 64/255; B29C 64/295; B29C 64/393; B33Y 10/00; B33Y 30/00; B33Y 50/02

(52) U.S. Cl. CPC B29C 64/364; B29C 64/118; B29C 64/209; B29C 64/245; B29C 64/255; B29C 64/295; B29C 64/393; B33Y 10/00; B33Y 30/00; B33Y 50/02; B29C 2791/004

(57) ABSTRACT

An aerosol evacuation system includes an intake proximate to a nozzle of an additive manufacturing system and arranged to receive a volume of air local to an outlet of the nozzle. The aerosol evacuation system also includes a conduit connected to the intake and arranged to define a passageway for airflow, a pump arranged to draw the airflow and particles emitted from the nozzle into the conduit through the intake, and a filtration system connected to the conduit and arranged to filter the airflow to remove ultrafine particles from the airflow.

### CROSS-REFERENCE TO RELATED APPLICATION

This application claims priority to U.S. Provisional Patent Application Ser. No. 63/486,061, filed on Feb. 21, 2023, the entire content of which is incorporated by reference.

### GOVERNMENT CONTRACT

The invention was made with government support under Contract Award Number N68335-22-C-0609 to ARIA, LLC by the U.S. Navy. The government may have certain rights in the invention.

### BACKGROUND

The field of the disclosure relates generally to additive manufacturing systems, and more particularly, to local aerosol evacuation systems for additive manufacturing systems.

At least some additive manufacturing systems involve the buildup of a material to make a component. These techniques can produce complex components from precursor materials at a reduced cost and with improved manufacturing efficiency. For example, in polymer-based 3D printers, a molten polymer is extruded through a nozzle and deposited onto a surface of a build plate. The extruded material may be deposited in a single pass or in multiple layers and the process may be repeated until a completed component is manufactured by the system.

During operation, additive manufacturing systems, such as polymer-based 3D printers, may emit particles with diameters ranging from 0.007-25 microns, i.e., ultrafine particles (UFPs). For example, these particles are generated as molten polymer is extruded through a nozzle of an extruder and deposited onto the surface of a build plate. UFPs are emitted from the material and propagate into the surrounding air. The Environmental Protection Agency (EPA) has stated that particulate matter smaller than 10 microns poses a health threat to the respiratory and cardiovascular system. For example, particles less than 10 microns can be inhaled and deposited through the airways of the lungs causing potential tissue damage, lung inflammation, and respiratory diseases. Additionally, the severity of the exposure effects may be proportional to the exposure duration. As a result, there are efforts to launch standardized testing limits for measuring particle emissions in the 3D printers, and establish exposure level limits based on particle size.

Some additive manufacturing systems include fume hoods or other large air exchange systems to remove particles by gradually exchanging an entire volume of air in a build chamber through a large filtration system. However, the fume hoods may not remove all particles because the particles are not drawn directly into the fume hoods. Also, the fume hoods take an extended time to exchange the entire volume of air and the particles may diffuse outward from the build chamber during the time required to complete an air exchange. In addition, the fume hoods may be noisy and costly to operate because they handle the entire volume of air.

As a result, there is a need for a system that efficiently and effectively removes harmful particulates that are generated during the 3D printing process.

### BRIEF DESCRIPTION

In one aspect, an additive manufacturing system includes a build plate, a supply of build material, and a nozzle connected to the supply and including an outlet. The build material is extruded through the outlet of the nozzle and deposited onto the build plate. The additive manufacturing system also includes an aerosol evacuation system including an intake arranged to receive a volume of air local to the outlet of the nozzle, a vacuum source arranged to draw airflow and particles emitted with the build material into the intake, and a filtration system connected to the intake and arranged to filter the airflow drawn into the intake to remove ultrafine particles from the airflow.

In another aspect, an aerosol evacuation system includes an intake proximate to a nozzle of an additive manufacturing system and arranged to receive a volume of air local to an outlet of the nozzle. The aerosol evacuation system also includes a conduit connected to the intake and arranged to define a passageway for airflow, a pump arranged to draw the airflow and particles emitted from the nozzle into the conduit through the intake, and a filtration system connected to the conduit and arranged to filter the airflow to remove ultrafine particles from the airflow.

In yet another aspect, a method of operating an additive manufacturing system includes extruding a build material through an outlet of a nozzle, directing airflow local to the outlet of the nozzle into an intake while the build material is extruded through the outlet of the nozzle, and filtering the airflow to remove ultrafine particles from the airflow.

### DRAWINGS

Features, aspects, and advantages of the present disclosure will become better understood when the following detailed description is read with reference to the accompanying drawings in which like characters represent like parts throughout the drawings.

FIG. 1 is a schematic diagram of an example local areosol evacuation system (LAES) for a 3D printer.

FIG. 2 is a schematic diagram of an example LAES including a plurality of pumps.

FIG. 3 is a perspective view of an LAES intake that is integrated into a nozzle of a 3D printer.

FIG. 4 is a perspective view of an example additive manufacturing system and a portion of an LAES attached to a print head of the additive manufacturing system.

FIG. 5 is a perspective view of a portion of the print head of the additive manufacturing system shown in FIG. 4, illustrating the LAES attached to the print head.

FIG. 6 is a bottom view of the print head of FIGS. 4 and 5, illustrating an LAES intake surrounding a nozzle of the print head.

FIG. 7 is a flow diagram of a method of manufacturing a component with the additive manufacturing system shown in FIG. 4.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer” and related terms, e.g., “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer- readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As described herein, examples of a Local Aerosol Evacuation System (LAES) remove harmful ultrafine particles (UFPs) and volatile organic compounds (VOCs) at the source during a 3D printing process. The intake of LAES is located near, on, or within the nozzle of the printer and prevents these particles from propagating to the surrounding air by capturing them imediately when they are emitted and while they are still in a densely packed volume near the nozzle tip. The captured particles and a small volume of air are transported directly to a series of filters through a network of inert tubing. The intake and inert tubing prevent particles from falling back down to the surface of the printer during the evacuation process.

For example, an LAES may be comprised of: an intake, transport tubing, particulate filters, actuators, monitoring sensors and gauges, containment boxes, controllers, manifolds, and pumps. Because the LAES is modular there are many possible combinations of components.

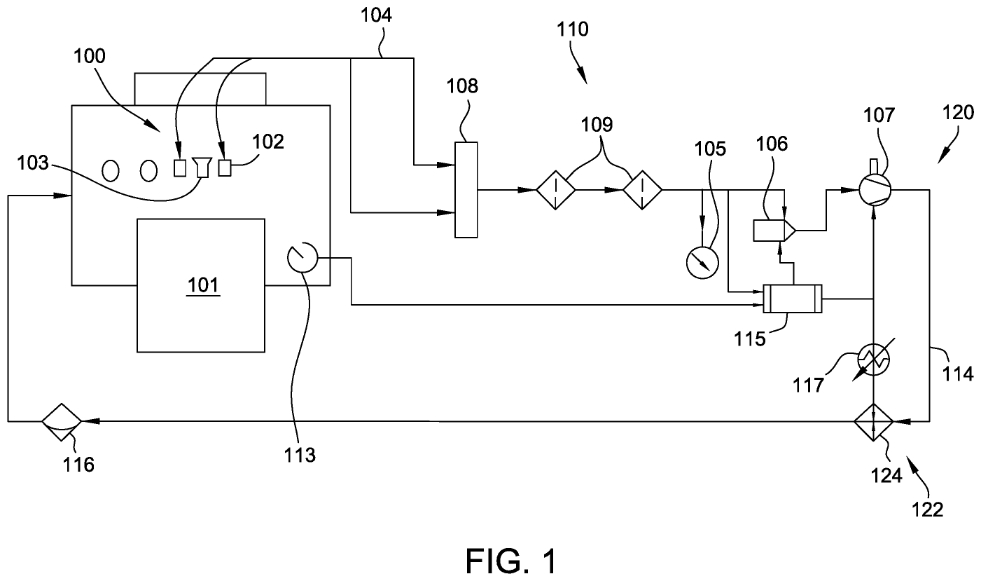

FIG. 1 is a schematic diagram of an example local areosol evacuation system (LAES) 100 for a 3D printer 101, broadly an additive manufacturing system. The 3D printer 101 is configured to construct components from a build material. For example, the 3D printer 101 may be a polymer-based 3D printer in which a molten polymer is extruded through a nozzle 103 and deposited onto a surface of a build plate. The LAES 100 captures and removes ultrafine particles (UFPs) and volatile organic compounds (VOCs) emitted from the molten polymer. In other embodiments, the LAES 100 may be used with any additive manufacturing system. For example, the LAES 100 is modular and may be retrofitted to an additive manufacturing system by attaching the LAES 100 to the nozzle and/or another component of the additive manufacturing system.

The LAES 100 includes an intake 102 proximate to a nozzle 103 of the 3D printer 101. For example, the intake 102 may be located near, on, or within the nozzle 103. In the example, the intake 102 includes two or more components defining two or more inlets and mounted on sides of the nozzle 103. In other examples, the intake 102 is a single component. In further examples, the intake 102 is integrated into the nozzle 103.

The intake 102 is sized to receive a volume of air that is local to the nozzle 103. For example, the intake 102 may be the same size or smaller than the nozzle 103. Also, the intake 102 is shaped to prevent UFPs from escaping the region local to the nozzle tip. For example, the intake 102 is a cone, cylinder, cube, trapezoid, and/or any other suitable shape.

Also, the LAES 100 includes a conduit 104 connected to the intake 102 and arranged to define a passageway for airflow and particles trapped in the airflow to be transported away from the intake. For example, the conduit 104 includes tubes connected to one or more outlet ports on the intake 102 and extending away from the intake. The conduit 104 may include rigid pipes, flexible tubing, and/or any other suitable conduit. The conduit 104 is connected to the intake 102 and may include independent lines extending to corresponding pumps 107 or extending to a manifold 108 that runs to a single pump 107. In addition, the conduit 104 may include valves and actuators 106. The actuators 106 are connected to the valves and are configured to position the valves to regulate the airflow through the conduit 104 and are controlled to provide at least one of a desired internal state of the LAES 100 or a desired external environmental state. The actuators 106 may be manually controlled by a user and/or automatically controlled.

The LAES 100 includes one or more pumps 107 arranged to draw the airflow and particles into the conduit 104 through the intake. In the example, the LAES 100 includes a single pump 107 that is actively controlled. For example, a controller 115 regulates operation of the pump to generate a vacuum at the intake 102 and provide a sufficient airflow in the conduits 104 to draw a volume of air local to the nozzle 103 into the intake 102. For example, the pump 107 may include a motor that is connected to and configured to rotate an impeller in flow communication with the passageway of the conduit 104.

The LAES 100 includes a filtration system 110 connected to the conduit 104 and arranged to filter the airflow to remove UFPs, VOCs, and/or any other materials from the airflow. The filtration system 110 includes one or more filters. For example, the filtration system 110 includes particulate filters 109 that may contain single or multiple stages. Multiple stage filters may be arranged in series in descending order with respect to rated particle size. Single stage filters may be rated to the smallest desirable size particle that is to be filtered by the system. The filters 109 may be arranged upstream and/or downstream of the pump 107. In the example, the filters 109 are positioned upstream of the pump 107 to filter out materials before the airflow reaches the pump.

The LAES 100 includes a recirculation system 120 that directs at least a portion of the airflow into a build chamber of the 3D printer 101 after the airflow flows through the filtration system 110. In the example, the recirculation system 120 includes an air conditioning system 122 that regulates the temperature and/or humidity of the airflow prior to the airflow being directed into the build chamber. For example, the air conditioning system 122 includes a heat exchanger 124 with a heat source 117 and/or a cooling element. In addition, in the example, the air conditioning system 122 includes a separator 116 that regulates the humidy of the airflow. A controller 115 is configured to operate the air conditioning system 122 to regulate at least one of a temperature or a humidity of the airflow based on a stored setpoint. The conditioned airflow may be delivered to a build chamber of the 3D printer 101 via a recirculation line 114 extending from the heat exchanger 124 to the build chamber.

During operation, the build material is extruded through the nozzle 103 and the intake 102 captures emitted UFPs and VOCs in an airflow that is drawn into inlets of the intake. The airflow travels through one or more ducts within the intake 102 to one or more outlet ports connected to the conduit 104. The airflow is then transported to the particulate filters 109 that remove UFPs from the airflow as the airflow travels to downstream components. After filtration, the airflow may be exhausted and/or reused. In the example, the filtered and conditioned air is directed, via the recirculation system 120, into the build chamber of the 3D printer 101.

To maintain a desired internal system state (flow rate, pressure gradient, temperature gradient, etc.), gauges or sensors 105 such as but not limited to pressure gauges, flow meters, and thermocouples may be distributed along the system. The LAES 100 can be controlled in an active or passive manner. When controlled in an automated (active) manner, the gauges 105 provide feedback for the controller 115 and the controller determines a corrective action based on the feedback if the operating state is outside set points. The controller sends signals to and operates the actuators 106 to achieve the corrective action. For example, the controller 115 may receive feedback from a UFP sensor 113 that monitors an environmental state of the build chamber and/or the LAES 100. Additionally or alternatively, gauges 105 may be distributed in the external environment depending on what state variables are to be controlled. The controller 115 receives sensor information regarding the internal system and external environmental state and determines corresponding corrective actions until the desired internal and/or external state is reached. For example, the controller 115 compares temperature, humidity, and/or flow rate to stored set points and adjusts operation of the LAES 100 if the parameters do not match the set points. In addition, the controller 115 may operate the LAES 100 based on information relating to an operating state of the 3D printer 101. For example, the controller 115 may increase or decrease the flow rate of the airflow into the intake 102 if a particle level or other parameter is above or below a set point.

Once the UFPs have been removed, clean filtered air may be discharged to the ambient air and/or sent to back to the temperature-controlled build chamber within the 3D printer 101 via a recirculation line 114. If the airflow is directed toward the build chamber, the airflow may be conditioned to match conditions within the build chamber. For example, the temperature of the clean air within the recirculation line 114 is increased via the heat exchanger 124 and the heat source 117 and/or decreased via a cooling element. The conditioned air may then be passed through the separator 116 in which excess humidity can be condensed/removed from the airflow that passes back into the build chamber of the 3D printer 101. The controller 115 regulates the conditions of the recirculated air to match the initial conditions of the build chamber which may be at a temperature and/or humidity that is different than the ambient air surrounding the printer 101.

In the example, the LAES 100 includes one or more of the controllers 115 that are configured to receive feedback and/or operate components of the LAES and/or additive manufacturing system. The controller 115 includes a computer system that includes at least one processing device (not shown in FIG. 1) and at least one memory device (not shown in FIG. 1) that executes executable instructions to operate the LAES and/or additive manufacturing system. The controller 115 includes, for example, a calibration model of LAES and/or additive manufacturing system and an electronic computer build file associated with a component, a 3D model of a component, an air temperature and/or pressure, and/or filtration information. The calibration model includes, without limitation, an expected build material required and temperature under a given set of operating conditions of the LAES 100 and/or the 3D printer 101. The build file includes build parameters that are used to control one or more components of LAES 100 and/or the 3D printer 101.

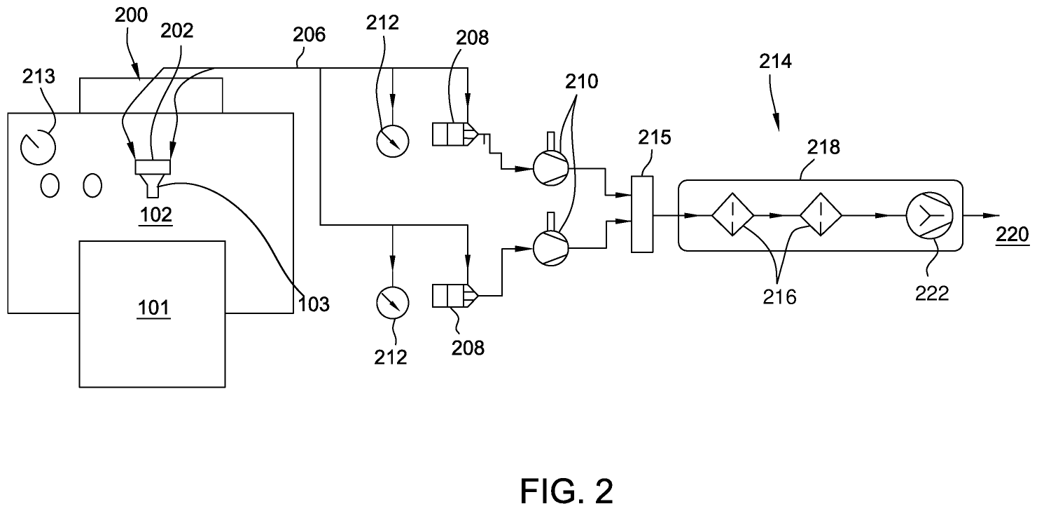

FIG. 2 is a schematic diagram of an example LAES 200. The LAES 200 includes an intake 202 proximate to the nozzle 103 of the 3D printer 101. For example, the intake 202 is attached to and surrounds the nozzle 103. The intake 202 is a single component and includes outlet ports that are connected to a conduit 206 arranged to define a passageway for airflow. The conduit 206 may include rigid pipes, flexible tubing, and/or any other suitable conduit. In addition, the conduit 104 may include valves and actuators 208. The actuators 208 are configured to be manually adjusted to position the valves to regulate the airflow through the conduit 206. In some embodiments, a controller (e.g., the controller 115 shown in FIG. 1) is configured to automatically adjust a position of the valves.

The LAES 200 includes a pair of pumps 210 that generate airflow in the conduit 206. For example, the pumps 210 may each include a motor that is connected to and configured to rotate an impeller in flow communication with the passageway through the conduit 206. Gauges 212 such as but not limited to pressure gauges, flow meters, and thermocouples may be distributed along the system. The LAES 200 includes, for example, a UFP sensor 213.

The LAES 200 includes a filtration system 214 connected to the conduit 206 and arranged to filter the airflow to remove UFPs and VOCs from the airflow. A manifold 215 is positioned downstream of the pumps 210 and upstream of the filtration system 214 to combine the airflows expelled from the pumps into a single airflow prior to the airflow being filtered. Accordingly, the filtration system 214 is able to process a single airflow instead of multiple airflows. In other embodiments, the manifold 215 is omitted and multiple airflows are filtered independently.

The filtration system 214 includes one or more filters. For example, the filtration system 214 includes particulate filters 216 positioned within a containment box 218. In the example, the filtration system 214 is arranged downstream of the pumps 210. Once the UFPs and VOCs have been removed, the clean air may be discharged from the containment box 218 to ambient air 220. For example, a fan 222 is positioned by an exhaust downstream of the particulate filters 216 and configured to discharge airflow from within the containment box 218 to an exterior.

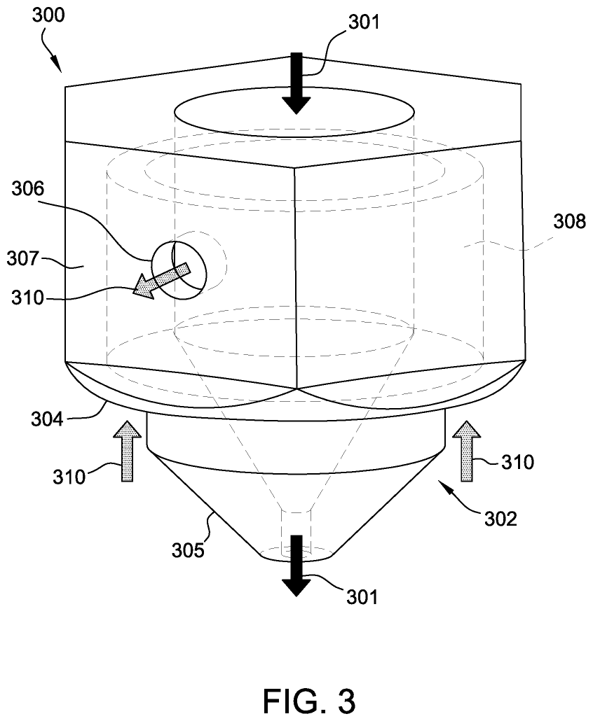

FIG. 3 is a perspective view of an LAES intake 300 that is integrated into a nozzle 302 of a 3D printer. The nozzle 302 is configured for a build material 301 to be extruded through the nozzle and out of an outlet on a tip 305 of the nozzle. The build material 301 emits UFPs, VOCs, and hazardous materials. The LAES intake 300 is arranged to receive a volume of air and materials in the air local to the outlet of the nozzle 302.

The LAES intake 300 includes an inlet 304 surrounding the tip 305 of the nozzle 302. For example, the inlet 304 is annular and is defined between the tip 305 of the nozzle 302 and a sidewall 307 of the intake 300. The inlet 304 extends continuously and unobstructedly around the tip 305.

In addition, the intake 300 includes one or more outlet ports 306 and one or more ducts 308 extending from the inlet to the outlet port. In the example, the duct 308 is a cylinder defined between the sidewall 307 and the nozzle 302 and extending from the inlet 304 axially beyond the outlet port 306. During operation, airflow 310 is drawn into the LAES intake 300 through the inlet 304, and flows through the one or more ducts 308 within the nozzle 302 to the one or more outlet ports 306 connected to the conduit 104 shown in FIG. 1 or the conduit 206 shown in FIG. 2.

The LAES intake 300 and the nozzle 302 are integrally formed as a single piece. For example, the sidewall 307 of the LAES intake 300 and the tip 305 of the nozzle 302 are molded or otherwise formed together to be a single piece that cannot be separated without damaging the components. In other embodiments, the LAES intake 300 and the tip 305 of the nozzle 302 are formed as separate pieces.

The system is simple to assemble and less complex because the LAES intake 300 is incorporated into the nozzle 302. For example, the LAES does not require additional intake components on the nozzle 302 and the intergrated LAES intake 300 is positioned to immediately and directly capture particles emitted at the nozzle 302.

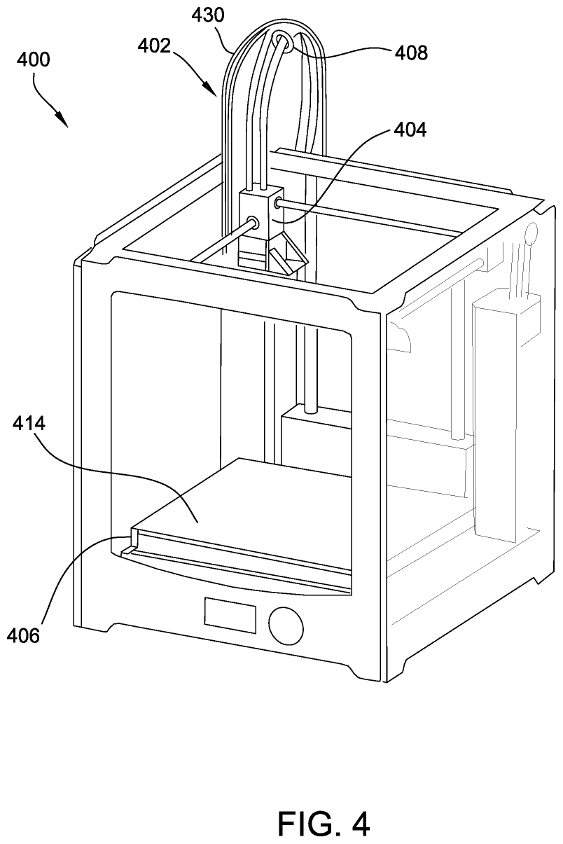

FIG. 4 is a perspective view of an example additive manufacturing system 400 and a portion of an LAES 402 attached to a print head 404 of the additive manufacturing system. For example, the additive manufacturing system 400 is illustrated in the form of a polymer-based 3D printer. Although the examples are described with reference to a 3D printer, this disclosure also applies to other types of additive manufacturing systems.

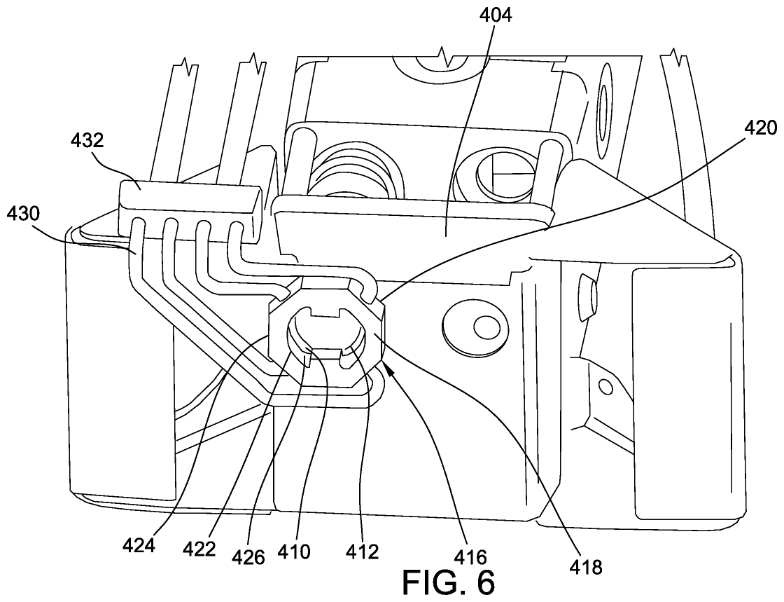

Referring to FIGS. 4-6, the additive manufacturing system 400 includes the LAES 402, the print head 404, a build plate 406, and a supply of build material 408. The print head 404 includes a nozzle 410 (shown in FIG. 6) connected to the material supply 408. The nozzle 410 includes an outlet 412. During operation of the additive manufacturing system 400, the build material is extruded through the outlet 412 of the nozzle 410 and deposited onto a surface 414 of the build plate 406. For example, the build material may comprise a molten polymer which is extruded through the nozzle 410 and deposited onto the surface 414 of the build plate 406. The additive manufacturing system may include a heater within the print head 404 and/or the material supply 408 to melt or maintain the molten polymer in an extrudable state. The build material and/or the extrusion of the build material emits particles including ultrafine particles (UFPs) and volatile organic compounds (VOCs) into the air local to the nozzle 410. Suitably, the LAES 402 is arranged to directly and immediately capture the particles with a volume of air surrounding the nozzle 410 and filter the particles out of the air.

The additive manufacturing system 400 may include additional components. For example, the additive manufacturing system 400 may include a monitoring camera or other sensors configured to monitor the build of the component and/or the environment around the component. The additive manufacturing system 400 may include a controller configured to receive information from the sensors and determine at least one of an internal state or an external environmental state relative to the additive manufacturing system based on the information from the sensor. For example, the sensors may detect a temperature, humidity, particle level, flow rate (cfm), and/or other airflow parameter of the additive manufacturing system 400. The controller may control operation of the additive manufacturing system 400 and/or the LAES 402 based on the detected parameter(s). For example, the controller is configured to compare the internal state or the external environmental state to a desired state and operate the LAES 402 to reach the desired state based on the comparison.

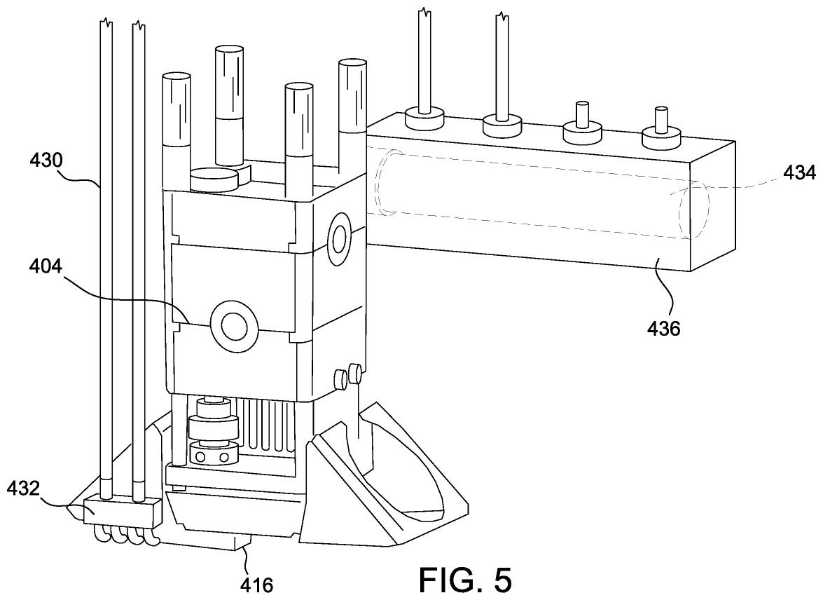

FIG. 5 is a perspective view of a portion of the print head 404 of the additive manufacturing system 400. FIG. 6 is a bottom view of the print head 404. In the example, the LAES 402 is attached to the print head 404. The LAES 402 includes an intake 416 proximate to the nozzle 410 and that at least partly surrounds the outlet 412 of the nozzle.

As shown in FIG. 6, the intake 416 is mounted to a bottom of the print head 404 via, for example, mechanical fasteners. The intake 416 is a ring and comprises a lower annular wall 418, an upper annular wall 420, an inner circumferential wall 422, and an outer circumferential wall 424. The inner and outer circumferential walls 422, 424 extend between the upper and lower annular walls 420. The upper annular wall 420 is in contact with the bottom of the print head 404. The intake 416 includes ports 426 that include holes or bores defined in the inner circumferential wall 422 and the outer circumferential wall 424. The ports 426 are spaced circumferentially around the outlet 412 of the nozzle 410 and arranged to receive particles entrained in an airflow immediately when the particles are emitted from the build material extruded through the nozzle 410.

Referring to FIGS. 4-6, the LAES 402 includes a conduit 430 connected to the ports 426 of the intake 416 and defining a passageway for the airflow. A vacuum source may be arranged to draw the airflow and particles emitted with the build material into the intake 416, and through the conduit 430. In the example, the conduit 430 includes a set (e.g., four) of pipes or tubes that extend from the intake 416 to a manifold 432. The manifold 432 connects the tubes of the conduit 430 together and provides a location to coallate airflows into a larger passageway. In the example, two pipes or tubes extend from the manifold 432.

The LAES 402 includes a filtration system 434 connected to the intake 416 via the conduit 430 and arranged to filter the airflow drawn into the intake 416 to remove ultrafine particles from the airflow. The filtration system 434 includes one or more filters positioned in a containment box or housing 436. The manifold 432 is positioned between the intake 416 and the filtration system 434. The conduit 430 includes one or more tubes that extend from the manifold 432 to the filtration system 434.

As shown in FIGS. 4-6, the LAES 402 is modular and may be used with different configurations of an additive manufacturing system. For example, the intake 416 is configured to mount on an exterior of the nozzle and can be mounted on different additive manufacturing systems. In addition, the LAES 402 acts as a self contained unit. Accordingly, the LAES 402 may be retrofitted to existing additive manufacturing systems. The LAES 402 may be cost less and be simpler to manufacture because the LAES includes less components and is modular.

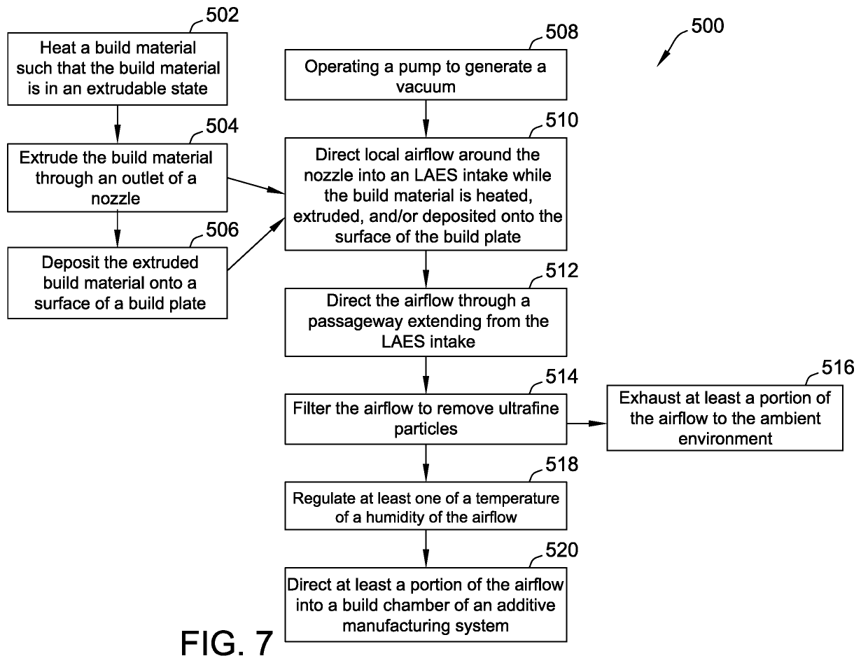

FIG. 7 is a flow diagram of a method 500 of manufacturing a component while using the LAES 100 (shown in FIG. 1), the LAES 200 (shown in FIG. 2), and/or the additive manufacturing system 400 and the LAES 402 (shown in FIGS. 4-6). Referring to FIGS. 4-7, for example, the method 500 includes heating 502 a build material such that the build material is in an extrudable state and extruding 504 the build material through an outlet (e.g., outlet 412) of a nozzle (e.g., nozzle 410). Particles (e.g., UFPs and VOCs) are emitted as the build material is heated and extruded. The extruded build material is deposited 506 onto a surface of a build plate (e.g., build plate 406).

The method 500 includes operating 508 a pump(s) to generate a vacuum, and directing 510 local airflow around the nozzle into an LAES intake (e.g., intake 416) while the build material is heated, extruded, and/or deposited onto the surface of the build plate. For example, the pump is connected to the intake by a conduit defining one or more passageways and the pump generates a vacuum in the conduit and the intake to draw air into the intake.

As a result, the LAES intake receives the volume of air local to the nozzle and captures any particles emitted by the additive manufacturing system. The LAES does not exchange the entire volume of air in the build chamber and only needs to draw air local to the nozzle because the LAES intake is located directly at the nozzle where the particles are emitted. Moreover, the LAES is arranged to immediately capture the particles before the particles are disbursed into air within or exterior to the build chamber. In some embodiments, the LAES is configured to withdraw and exchange and entire volume of air in the build chamber.

The airflow is directed 512 through a passageway extending from the LAES intake, and the airflow is filtered 514 to remove particles. For example, a filtration system (e.g., the filtration system 110) includes one or more filters connected in flow communication with the passageway and configured to remove particles in the airflow. The filtration system may filter the particles upstream or downstream of the pump and/or other components.

The method 500 includes exhausting 516 at least a portion of the airflow to the ambient environment and/or directing 520 at least a portion of the airflow into the build chamber of the additive manufacturing system. The method 500 includes regulating 518 at least one of a temperature or a humitidity of the airflow before the airflow is directed into the build chamber.

The present application comprises a novel local aerosol evacuation system for additive manufacturing systems that removes harmful aerosols or particles at the source during the manufacturing process. An intake that is located near, on, or within the nozzle captures contaminated air and the air is transported through a network of tubing en route to filtration system. Transportation of the air is driven by one or more pumps. The system is capable of being manually controlled and/or automatically controlled. A plurality of sensors monitors internal system states and environmental states and provides feedback to a controller that provides corrective actions to actuators within or external to the system. The system may be configured as an open or closed system in which filtered air is discharged into the ambient air or recirculated back into the build chamber of the additive manufacturing system. Prior to re- entering the build chamber of the additive manufacturing system, the air may be conditioned in such a way as to match the original conditions of the build chamber.

Embodiments of additive manufacturing systems with an aerosol evacuation system described herein remove particles emitted from the build process. Accordingly, the systems reduce harmful emissions from the additive manufacturing systems and provides a cleaner environment within and around the build chamber.

An exemplary technical effect of the methods and systems described herein includes: (a) reducing ultrafine particles or VOCs emitted from additive manufacturing systems; (b) reducing health risks to people operating additive manufacturings systems from emissions of the additive manufacturing systems; (c) improving the air quality of the ambient environment in and around additive manufacturing systems; and (d) reducing impurities or defects in additively manufactured components that may be caused by particles in the air.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

Exemplary embodiments of additive manufacturing systems having local aerosol evacuation systems are described above in detail. The apparatus, systems, and methods are not limited to the specific embodiments described herein, but rather, operations of the methods and components of the systems may be utilized independently and separately from other operations or components described herein. For example, the systems, methods, and apparatus described herein may have other industrial or consumer applications and are not limited to practice with additive manufacturing systems as described herein. Rather, one or more embodiments may be implemented and utilized in connection with other industries.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An additive manufacturing system, comprising:
a build plate;
a supply of build material;
a nozzle connected to the supply and including an outlet, wherein the build material is extruded through the outlet of the nozzle and deposited onto the build plate; and
an aerosol evacuation system comprising:
an intake arranged to receive a volume of air local to the outlet of the nozzle;
a vacuum source arranged to draw airflow and particles emitted with the build material into the intake; and
a filtration system connected to the intake and arranged to filter the airflow drawn into the intake to remove ultrafine particles from the airflow.

2. An additive manufacturing system in accordance with claim 1, further comprising a controller and at least one sensor configured to detect a parameter of the aerosol evacuation system, wherein the controller is configured to receive information from the sensor and determine at least one of an internal state or an external environmental state relative to the aerosol evacuation system based on the information from the sensor.

3. An additive manufacturing system in accordance with claim 2, wherein the controller is configured to compare the internal state or the external environmental state to a desired state and operate the aerosol evacuation system to reach the desired state based on the comparison.

4. An additive manufacturing system in accordance with claim 1, wherein the aerosol evacuation system comprises an air conditioning system and a controller configured to operate the air conditioning system to regulate at least one of a temperature or a humidity of the airflow.

5. An additive manufacturing system in accordance with claim 1, wherein the aerosol evacuation system comprises a recirculation system that directs at least a portion of the airflow into a build chamber of the additive manufacturing system after the airflow flows through the filtration system and the air conditioning system.

6. An additive manufacturing system in accordance with claim 1, further comprising a plurality of valves and actuators connected to the valves, wherein the actuators are configured to position the valves to regulate the airflow through the aerosol evacuation system and provide at least one of a desired internal state or a desired external environmental state.

7. An additive manufacturing system in accordance with claim 1, further comprising rigid pipes or flexible tubing connecting the intake, the vacuum source, and the filtration system.

8. An additive manufacturing system in accordance with claim 7, wherein the vacuum source comprises at least one pump.

9. An additive manufacturing system in accordance with claim 8, wherein the filtration system is arranged upstream of the pump.

10. An additive manufacturing system in accordance with claim 1, wherein the build material is a molten material that is extruded through the nozzle, wherein the supply includes a heater to melt or maintain the molten material in an extrudable state.

11. An aerosol evacuation system, comprising:
an intake proximate to a nozzle of an additive manufacturing system and arranged to receive a volume of air local to an outlet of the nozzle;
a conduit connected to the intake and arranged to define a passageway for airflow;
a pump arranged to draw the airflow and particles emitted from the nozzle into the conduit through the intake; and
a filtration system connected to the conduit and arranged to filter the airflow to remove ultrafine particles from the airflow.

12. An aerosol evacuation system in accordance with claim 11, further comprising an air conditioning system and a controller configured to operate the air conditioning system to regulate at least one of a temperature or a humidity of the airflow.

13. An aerosol evacuation system in accordance with claim 12, further comprising a recirculation system that directs at least a portion of the airflow into a build chamber of the additive manufacturing system after the airflow flows through the filtration system and the air conditioning system.

14. An aerosol evacuation system in accordance with claim 11, further comprising a plurality of valves and actuators connected to the valves, wherein the actuators are configured to position the valves to regulate the airflow through the conduit and provide at least one of a desired internal state or a desired external environmental state.

15. An aerosol evacuation system in accordance with claim 11, wherein the conduit comprises rigid pipes or flexible tubing.

16. An aerosol evacuation system in accordance with claim 11, wherein the filtration system is arranged upstream of the pump.

17. A method of operating an additive manufacturing system; the method comprising:
extruding a build material through an outlet of a nozzle;
directing airflow local to the outlet of the nozzle into an intake while the build material is extruded through the outlet of the nozzle; and
filtering the airflow to remove ultrafine particles from the airflow.

18. A method in accordance with claim 17, further comprising depositing the build material onto a surface of a build plate.

19. A method in accordance with claim 17, wherein directing the airflow around the nozzle into the intake comprises operating a pump to generate a vacuum to draw the airflow into the intake.

20. A method in accordance with claim 17. further comprising regulating at least one of a temperature or a humidity of the airflow and directing at least a portion of the airflow into a build chamber of the additive manufacturing system.
